(19) United States
(12) Patent Application Publication
(10) Pub. No.: US 2009/0010026 A1
(43) Pub. Date: Jan. 8, 2009

(54) Radiating element for light panels and light panel manufactured using said radiating element

(76) Inventor: Giorgio Gai, Genova (IT)

Correspondence Address: Themis Intellectual Property Counsel, 7660 Fay Ave Ste H535, La Jolla, CA, 92037, US

(21) Appl. No.: 12/182,133

(22) Filed: Jul. 30, 2008

(30) Foreign Application Priority Data
Jan. 31, 2007 (IT) GE2007A000073

(51) Int. Cl. F21V 7/04

(52) U.S. Cl. 362/609

(57) ABSTRACT

A radiating element for light panels includes a face providing a light radiation-emitting surface, a light source for sideward light generation and an element for reflecting and/or scattering the incident light. In one embodiment, the radiating element includes a half-shell shaped plate with a polygonal or round plan shape. A concave reflection and/or scattering side of the half shell faces the emitting surface and a central area opposite thereto defines an opening for receiving a light source, such that the light radiation emitted from the emitting head in a sideward direction is reflected and/or scattered in a predetermined percentage in a direction incident upon a light-emitting surface oriented transversally, preferably perpendicularly, to the central axis of symmetry of the reflection and/or scattering element. A light panel may be manufactured using one or a plurality of such radiating elements, which may arranged individually or in clusters.

### FIELD

The present invention relates to a radiating element for light panels and to a light panel manufactured therewith. More particularly, the present invention relates to a radiating element for light panels that includes a face providing a light radiation-emitting surface, a light source for sideward light generation and an element for reflecting and/or scattering the incident light.

### BACKGROUND

Light-emitting elements that are configured to emit light radiation from a surface and that have a substantially constant distribution of intensity over such surface are used as light sources in the manufacture of light panels. Such light panels typically include a thin, box-like member having one or two translucent and inner backlit surfaces, which have transparent films or paper sheets laid thereon and carry a picture or a message to be publicly displayed. Light panels of this kind are widely used in the fields of advertising, interior and exterior lighting, road and highway signs, and also in other fields.

Light-emitting elements suitable for use in light panels are known in the art, for example:

light panels with fluorescent or neon tubes, in which the tubes are disposed behind the light-emitting surface of the panel and illuminate the front of the light-emitting surface of the same panel;

light panels with a plate-like scattering element, in which the light radiation sources illuminate the scattering element from one or more delimiting sides of the scattering element, and in which scattering occurs in the direction of the front surface of the scattering element, causing the scattering element to become the light radiation-emitting surface. The related light sources may be fluorescent tubes, incandescent lamps and light emitting diodes (LEDs); or

light panels with front LEDs emitting light radiation from an emitting head directed towards the user, i.e. perpendicular or approximately perpendicular to the emitting surface of the panel. In this configuration, the LEDs are oriented towards the front and lie on the bottom of the panel, with each LED forming a unit point of minimum size, i.e. some sort of pixel of a luminous picture composed of a number of the LEDs.

All the above systems provide light panels but also suffer from drawbacks deriving from complex construction, inhomogeneous light intensity along the emitting surface, short life and difficult manufacture within industrial environments, causing the panels to be relatively expensive.

### SUMMARY

The present invention addresses on the problem of providing a light-emitting radiating element for light panels that has a simple and inexpensive construction and a smaller weight, and that requires a lower, simpler, and less time-consuming maintenance, while preserving and improving performance over light-emitting radiating elements and panels of the prior art.

The invention fulfills the above objective by providing a radiating element for light panels, in which a reflection/scattering element forms a tile element, individually or in mosaic form, and includes a half-shell shaped plate with a concave reflection/scattering side facing towards the emitting surface and a convex side opposite said emitting surface. The central area of the shell has an opening for receiving the light source which houses the radiating head within a depression of the concave side and at a focal point of said concave surface, so that the light radiation emitted from the emitting head of the light source in the sideward, i.e. radial direction, relative to the central axis of symmetry of the reflection/scattering element, is reflected/scattered in a predetermined percentage in a direction incident upon an emitting surface oriented along a plane transverse, preferably perpendicular to the central axis of symmetry of the reflection/scattering element.

The convex surface may be a reflective, mirror-like surface or a scattering, for example, white surface.

The half shell element that forms the tile may have any plan shape, e.g. a square or triangular shape or another regular or irregular polygonal shape.

Advantageously, the front concave surface facing towards the emitting side of the half-shell plate and/or the rear convex surface have a paraboloidal curvature.

The plate or sheet that forms the reflection/scattering element with its concave shape, is advantageously, but without limitation, made of a plastic material, preferably a heat deformable plastic material.

The plate forming the reflection/scattering element may be relatively thin and have a typical thickness for a vacuum and thermoforming process. These types of processes are known and widely used, for example in the fabrication of food-grade plastic containers or shaped, expanded fruit trays.

The light source typically consists of a radial or edge-emitting LED with a 360° light pattern as described in greater detail herein.

In one embodiment of the invention, the concave side of the half-shell reflection/scattering element is closed by a transparent or translucent element, which is configured to be coupled to the peripheral edge of the reflection/scattering element.

Preferably, the transparent closing element has the same or substantially the same plan shape as the reflection/scattering element.

The coupling of the half-shell reflection/scattering element with the transparent or translucent element may be provided by either continuous or discontinuous extensions, and may be provided by complementarily shaped end portions of the peripheral edge of both the reflection/scattering element and the closing element, such as clips or the like, that engage folded peripheral edges or peripheral edge segments forming peripheral coupling grooves along the peripheral edges of the reflection/scattering element and of the closing element.

Advantageously, the covering element or closing element has a surface area with a lower transmission coefficient, i.e. is less transparent, in a central portion coincident or coaxial with the light source head, as compared with the remaining peripheral portion. This surface area attenuates the intensity of the light radiation emitted at the light source head, at least approximately to the same level as the intensity of the light radiation emitted through the surface area of the transparent closing element with the higher transmission coefficient, i.e. surrounding such central portion. Thus, in addition to the advantage of closing the light source compartment to the external environment and of providing a tile that is externally closed and that has a very low weight and very low material, fabrication and assembly costs, the light intensity is radiated through said closing surface with optimized homogeneity, so that the emitted light radiation is substantially constant throughout the emitting surface, i.e. through the surface of the closing element.

In one embodiment of the invention, this central surface portion with the lower light transmission coefficient is a depressed central portion, i.e. a central depression of the surface of the closing element that is treated to reduce the transmission coefficient.

The closing element may also be formed with a vacuum and hot forming process from a thin plate of transparent plastic material, as discussed with regard to the reflection/scattering element.

The light source, i.e. the radial or edge-emitting LED, may be directly mounted onto the header of a printed circuit board, typically a glass epoxy laminate. Such header supports the printed circuit board that forms the power supply circuit for the light source and may also carry some of the circuit components of a power supply or power regulation circuit for said source, which is provided on one side of said header. The header is coupled or couplable to the half-shell reflection/scattering element whereas, in the mounted condition, said header extends tangent to the convex side of the reflection/scattering element in the area of the central light source receptacle. In this configuration, the light source projects cantilever-wise out of the concave side of the reflection/scattering element towards the focus of the paraboloid.

The LED may be attached to a metal plate, preferably made of aluminum, which provides for heat dissipation and fixation of the light-emitting radiating element to a load bearing structure. The metal plate is placed tangent or parallel to a position tangent to the convex side of the reflection/scattering element in the area of the central light source receptacle, and said light source projects cantilever-wise out of the concave side of the reflection/scattering element in the area of the focus of the paraboloid, whereas said reflection/scattering element is or may be attached to said metal plate.

The header or headers of the printed circuit board of a power supply circuit or a power regulating circuit for said light source may also be mounted onto said metal plate, for example in a slightly offset position and in the area peripherally surrounding the light source, causing the convex side of the reflection/scattering element to be spaced from the metal plate.

Typically, such metal plate is substantially coaxial or concentric with the plan shape of the reflection/scattering element.

The size of the radiation element depends on the type of light source that is used which may be a LED, and on the light intensity to be obtained through the emitting surface, with the side or diameter ranging from 5 cm to 30 cm.

In one alternative embodiment, the reflection/scattering element is formed of a thin metal sheet, for example an aluminum sheet, and has one side, for example the side designed to form the concave side, treated to become reflective and coated with a layer of material providing a scattering effect, for example, white paint. This sheet may be shaped by molding.

In another embodiment of the invention, two or more radiating elements as described above are integrated in a single element and the half-shell reflection/scattering element for two or more light sources is formed from a single sheet of material that is shaped to form two or more half-shells in side-by-side relationship on one or more sides.

Each of the reflection/scattering elements integrated in the radiation assembly may be formed completely or in part as described above with regard to a single radiating element.

A corresponding multiple closing element is provided, composed of an array of side-by-side single closing elements, each having a central portion with a lower light transmission coefficient, coincident with the light source of the corresponding reflection/scattering element of the array in the radiating assembly.

The multiple closing element also may include one or more of the features described above with reference to the closing element of the single radiating element.

The multiple covering element may be coupled to the corresponding array of reflection/scattering elements in a manner substantially identical to the single radiating element, at least along the coincident peripheral edges of the multiple closing element and of the array of reflection/scattering element.

In one embodiment of the invention, an array of single or multiple radiating elements is provided to cover various shapes and sizes of the surfaces to be illuminated. More particularly, an array of radiating elements is provided that has one or more single radiating elements, one or more double radiating elements, one or more triple radiating elements, one or more quadruple radiating elements, or one or more sextuple radiating elements, or a combination of such single or multiple radiating elements. For example, the single radiating elements may have a square plan shape.

The multiple radiating elements advantageously improves the efficiency of the construction, further reducing costs, weight, as well as construction and assembly complexity.

More particularly, the light sources may be mounted onto a common metal support sheet or the like, each light source being coincident with the receptacle of the corresponding reflection/scattering element. Printed circuit boards may be provided that are formed of an element shared by two or more light sources.

The combination of single radiating elements into multiple radiating elements provides various advantages, namely:

easier and less costly assembly of the radiating elements in the light panel;

easier and less costly power supply to the light sources. In particular, a combination of six single radiating elements having six 2 Watt LEDs enables a sextuple radiating elements to be powered by a 24 Volt direct current source and, by particular arrangements, other single or multiple elements can be also powered with a predetermined reference voltage;

less costly assembly of the multiple radiating elements; and

better storage conditions before assembly into a light panel.

In one embodiment the transparent covering element may include stiffening ribs arranged in a predetermined pattern over the surface of said covering element.

In another embodiment, the multiple covering element has a plurality of projecting spacers on a transparent or translucent plate of a light panel, which is illuminated by a radiating assembly of the above type.

The spacer elements are optional and their provision depends on the width of the plate, which can be very large and possibly cause buckling of the plate under its own weight.

These projections may be other than the ribs or at least partly formed of the above stiffening ribs.

The invention also relates to a light panel having at least one bearing frame for supporting a plurality of light emitting elements mounted onto the back of at least one translucent or transparent plate, which bears or supports graphical information formed by a combination of transparent and/or translucent surfaces having different colors and/or light transmission coefficients, the light emitting means including, according to the present invention, one or more single or multiple radiating elements as described above.

Further features of embodiments or the invention can be found in the detailed description and in the claims.

### BRIEF DESCRIPTION OF THE DRAWINGS

The drawings constitute a part of this specification and include exemplary embodiments of the invention, which may be embodied in various forms. It is to be understood that in some instances various aspects of the invention may be shown exaggerated or enlarged to facilitate an understanding of the invention.

The characteristics of the invention and the advantages deriving therefrom will appear more clearly from the following description of a few non-limiting embodiments which are illustrated in the accompanying drawings, in which:

FIG. 1 is a cross sectional view of a first embodiment of a single radiating element of the present invention.

FIG. 2 is a cross sectional view of a light panel comprising a plurality of radiating elements of FIG. 1.

FIG. 3 shows a covering element for a multiple radiating element.

FIGS. 4A-4D show different schematic configurations of multiple radiating elements composed of two, three, four and six single radiating elements having a square plan shape respectively.

FIG. 5 is a top plan view of the array of sextuple radiating element acting as light emitting means of a large light panel.

FIGS. 6A and 6B show two multiple radiating elements composed of four and eight single triangular radiating elements respectively.

FIGS. 7 to 9 show a single radiating element according to three different variant embodiments, differentiated in that they have no annular lens associated to the light source, or an annular lens with a frustoconical section or an annular square lens with a square section respectively.

FIGS. 10 to 12 and 13A to 13B are various views i.e., respectively, a cross sectional view as taken along line A of FIG. 11, a top plan view and a lateral long-side view and a perspective view in the assembled and exploded conditions respectively, of a multiple radiating element composed of six single radiating elements having a square plan shape arranged on two side-by-side rows of three single radiating elements each.

FIG. 14 shows an enlarged, partially sectional detail of the light source-associated portion of the radiating element.

FIG. 15 shows an alternative embodiment of a multiple radiating element and/or a light panel having light sources capable of side or radial light radiation emission over a 360° range.

FIG. 16 is a plan view of an exemplary light panel composed of elements having 6, 3, 2 and 1 base radiating elements.

### DETAILED DESCRIPTION

Detailed descriptions of embodiments of the invention are provided herein. It should be understood, however, that the present invention may be embodied in various forms. Therefore, the specific details disclosed herein are not to be interpreted as limiting, but rather as a representative basis for teaching one skilled in the art how to employ the present invention in virtually any detailed system, structure, or manner.

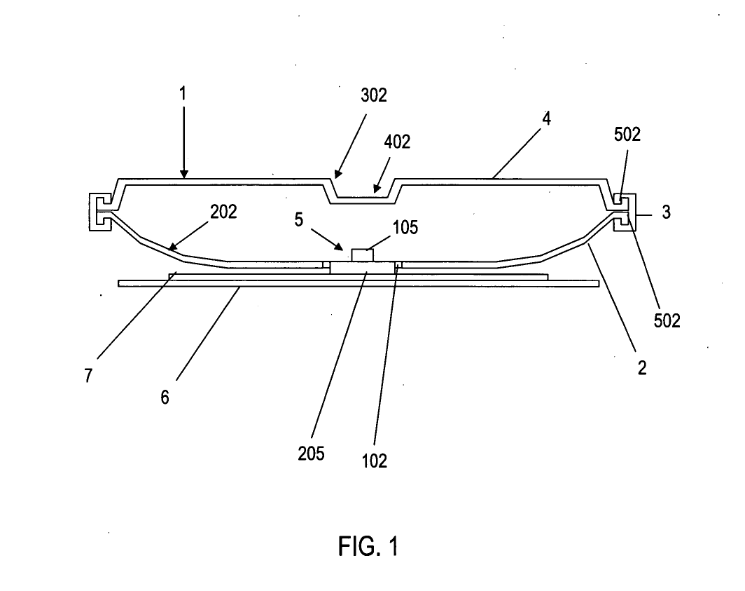

Referring to FIG. 1, a single radiating element 1 for illuminating light panels is composed of half-shell reflection/scattering element 2 having at least one concave surface 202. The half-shell may have any shape whatever, such as a circular, square, or triangular shape, or a polygonal shape having a greater number of angles. Preferably but without limitation, the sides of a polygonal share are regular and equilateral.

Concave surface 202 is rotationally symmetrical with respect to a central axis perpendicular to the plan shape of reflection/scattering element 2 and, for example, may have a paraboloidal shape.

The front side has a curvature that forms a reflection/scattering surface to reflect/scatter the light radiation coming in a direction radial to the central axis of symmetry of the half-shell and hence of the concave surface 202, so that the light rays having such radial direction and also having a predetermined orientation in relation to the central axis of symmetry (which might be defined as an opening in the azimuth direction) are reflected/scattered in a direction incident upon a plane oriented transversally, preferably perpendicularly, in relation to the axis of symmetry of concave surface 202.

The half-shell has a central receptacle 102 at its central portion, which is coaxial with the central axis of symmetry of concave surface 202, and which is configured for receiving socket 205 of a light source 5, whose light radiation emitting head 105 projects into the space defined by concave surface 202. Light source 5 is an edge-emitting source operating over a 360° range, i.e. a light source that emits light radiation with an intensity distribution, in which intensity is higher or concentrated in a direction radial to a central axis oriented in a desired light radiation emitting direction, with a predetermined opening in the plane containing said axis and with an angular extension corresponding to a round angle, i.e. 360°. In the embodiment of FIG. 1, light radiation is emitted at head 105 and the light radiation distribution is coaxial with the central axis of symmetry of reflection/scattering element 2, and particularly of concave surface 202.

In the embodiment illustrated in FIG. 1, reflection/scattering element 2 is formed of a thin sheet shaped to have a concave shape on concave surface 202 and a corresponding convex shape on the opposite side. Concave surface 202 is treated to reach a desired reflection/scattering coefficient, which can applied with different processes, e.g. through the application of a reflective white paint and/or buffing or other means.

Advantageously, the plate that forms reflection/scattering element 2 is made of a thermoformable plastic material and preferably has a thickness that enables shaping by a simple vacuum and hot forming process, also known as thermoforming. Such forming process is known to be used, for example, with food-grade packaging containers, expanded fruit trays, or the like.

The plate forming reflection/scattering element 2 may also be metal, such as aluminum. In this case, thickness is selected to enable the plate to be shaped by molding while ensuring that the half-shell has some structural stability.

Composite material plates can also be used, for example, multilayer plates having a composition that affords structural stability, formability, low weight and low cost.

Reflection/scattering element 2 has the concave side closed by a cover element 4 of transparent material which forms the light radiation emitting surface, on which the light radiation is directed that is emitted by source 5 laterally from the central axis of symmetry and deflected by concave surface 202. Cover element 4 is made of a transparent and/or translucent material and particularly of a transparent or translucent plastic material. As for reflection/scattering element 2, cover element 4 may include a thin thermoformable plate.

Cover element 4 may be coupled to the half-shell and as a reflection/scattering element to form a box-like radiating element containing emitting head 105 of the light source 5 in a predetermined position relative to concave surface 202. In particular, cover element 4 has a plan shape substantially identical to the plan shape of the reflection/scattering element 4 and is approximately congruent therewith. Cover element 4 and the half-shell that acts as reflection/scattering element 2 are mutually coupled along the peripheral edges, for example, with matching peripheral fixation flanges 502.

Such coupling may be continuous or discontinuous all along flanges 502 and may be attained, for example, by chemical/physical bonding, such as by welding, gluing or the like, or by detachable fastening, such as interlocking, or mutual clamping with screws and bolts or the like, or by clipping.

In the embodiment illustrated in FIG. 1, peripheral flanges 502 of the half-shell acting as reflection/scattering element 2 and cover element 4 are formed with a peripheral channel- or groove-like section open on opposite sides, thereby providing two opposite coupling grooves for C-shaped clips 3. Clips 3 may be discontinuous elements arranged along the peripheral extension of the two parts to be coupled, or a C-shaped continuous band may be provided.

In both variants, clips 3 may be either elastically deformed for snap engagement with flanges 502 or the clips may be inelastically deformed and then applied by shaping around flanges 502, so to clamp them together.

Still with regard to cover element 4, this element has a central portion 402, i.e. a portion coincident and/or possibly coaxial emitting head 105 of light source 5, that is provided with a lower light radiation transmission coefficient as compared with the rest of cover element 4. This arrangement has the purpose of attenuating a light radiation intensity peak towards the central axis of symmetry and of generating non-homogeneous distribution of the light intensity radiated from the surface of cover element 4.

According to the present embodiment, central portion 402 that is treated for radiation intensity attenuation includes a central depression 302 concentric and possibly coaxial with head 105 of light source 5, and the bottom and/or possibly the lateral parts of depression 302 are treated with processes of the type described above.

Light source 5 is supported by a base plate, which may be the header of the printed circuit board that forms the power supply circuit and/or the power regulation circuit or at least part of the power supply and/or power regulation circuits of light source 5. Such header bears, in the present embodiment, at least some of the circuit components, and may be further supported by a base plate that also acts as a heat sink.

The base plate may also act as a cooling plate and may be made of metal, aluminum or any other material with a high heat transmission coefficient. The base plate has the function of dissipating the heat generated by light source 5 and may in turn have, alongside light source 5, one or more printed circuit board headers for power supply and/or power regulation devices or for part of such devices or circuits.

FIG. 1 shows the above described solution, with source 5 and header 7 of the power supply or power regulation circuit or part of these circuits being supported by heat dissipation plate 6.

Heat dissipation plate 6 and/or the header also support reflection/scattering element 2 and cover element 4 that are or can be fixed, preferably in a detachable manner, to source 5 and/or header 7 and/or heat dissipation plate 6.

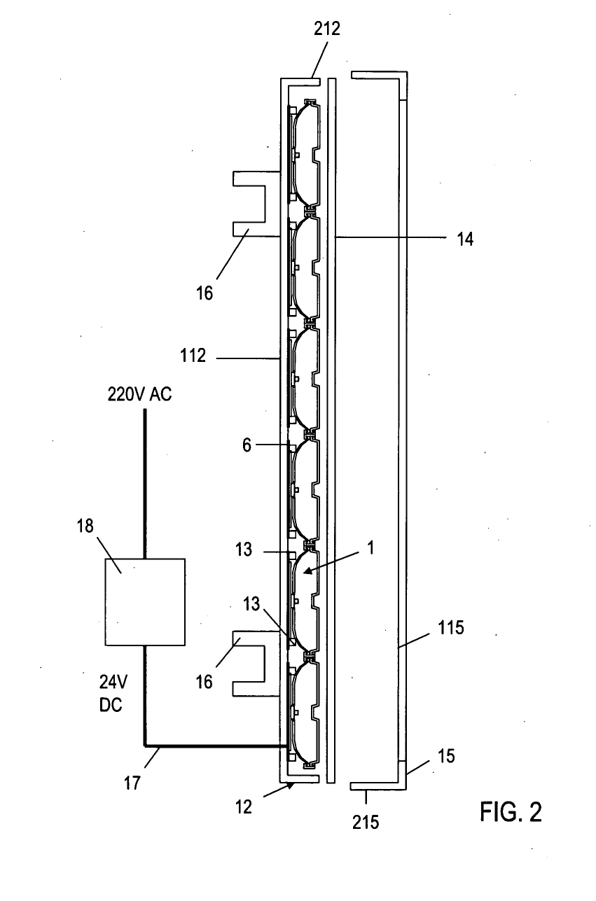

Depending on the construction variant selected from the above options, header 7 and/or heat dissipation plate 6 also act as a socket for connecting single radiating element 1 to a bearing structure of a device, in which radiating element 1 is used or located, like the light panel of FIG. 2 described in greater detail below.

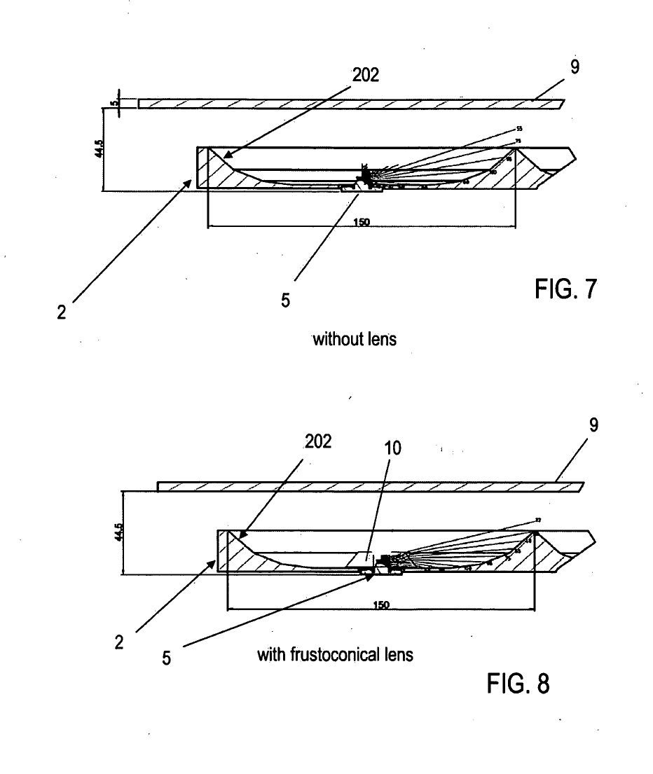

Referring to FIGS. 7 to 9, a variant embodiment is shown, in which the reflection/scattering element 2 is not formed as a half-shell with a relatively thin wall and hence with a concave-convex shape, but as a plate having one concave depression on one side, acting as a reflection/scattering surface 202.

These figures also show, on the right side, the intensity distribution pattern of the radiation emitted by the light source in various conditions and variants, as described in greater detail below.

In FIG. 7, the light source has no concentration lens and the opening angle of radiation in the radial direction causes part of the radiation to fall out of the concave, paraboidal reflection/scattering surface 202 and be lost and excluded from the overall radiation intensity emitted through the emitting surface, i.e. the cover element or the element or surface to be backlit, designated by numeral 9 in FIGS. 7 to 9.

In FIG. 8, the light source is provided in combination with an annular lens 10 having a ring trapezoidal cross section, and a frustoconical cross section along the external long diameter. Light emitting head 105 is held within the central opening of annular lens 10. This arrangement reduces the opening angle of radiation in the radial direction, thereby focusing a higher light intensity on the reflection/scattering surface 202.

The same effect is obtained using an annular lens of rectangular or square cross section, as shown in FIG. 9 and designated by numeral 11. The solution illustrated in FIG. 9 with the lens of square or rectangular cross section is an intermediate solution allowing recovery of a small part of the radiation emitted by the light source in the upper margin area of the opening cone, whereas the solution of FIG. 8 with frustoconical lens 10 enables recovery of a considerable amount of radiation, by deflecting it onto concave surface 202, and focuses the radially emitted radiation into an opening cone of smaller angular width, i.e. a smaller opening angle.

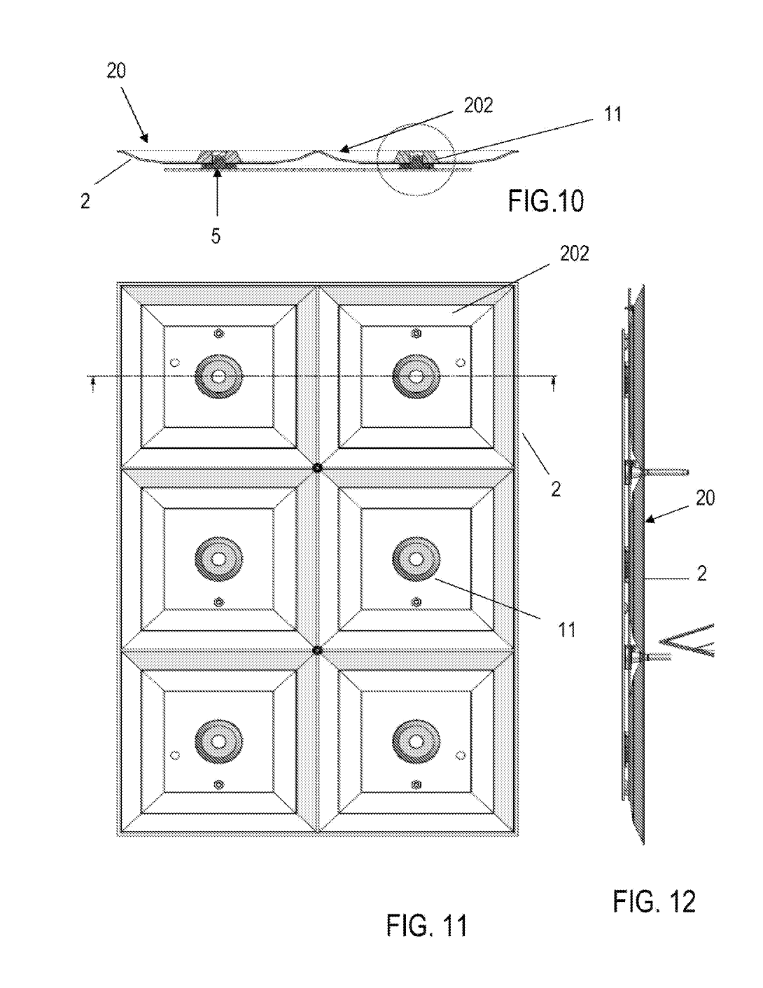

It can be noted, with reference to FIGS. 13A-13B, that annular lenses 10, irrespective of their shape, are separate parts designed to be coaxially coupled to light sources 5, i.e. to the part of the latter from which the light radiation is emitted and which is designated by numeral 105 in FIG. 14. Particularly, these parts are detachably fixed, such as by interlocking arrangements or other known detachable mechanical fixation, and annular lens 10 is especially coupled to reflective surface 202 all around the through opening for radiating head 105 of light source 5.

According to another feature of the present embodiment, the side of annular lens 10 that is designed to contact, be coupled or at least face towards the area of the reflective surface all around the through hole for light source 5 may be treated to become reflective. More particularly, such side of annular lens 10 may be covered with a white adhesive film and/or be subjected to pad printing or coated with a layer of white paint. Said surface of the annular lens 10 may also be subjected to any alternative treatment for providing said reflective surface on the side facing the inside of lens 10.

Referring to FIG. 2, radiating element 1 may be used for manufacturing light panels, i.e. panels in which a message, an image or else are emphasized by backlighting. Here, the panel may have various constructions, and light-emitting radiating element 1 may be used in combination with various constructive features.

A very simple light panel embodiment is shown in FIG. 2. In this embodiment, the panel frame has a box shape and is composed of a rear container or tray 12 having a bottom wall 112 and side walls 212. A plurality of radiating elements 1 are disposed in container or tray 12 in side-by-side relationship, in both height and width directions of tray 12, and are fixed in position using detachable fastener elements 13, such as screws, bolts, or other means, for example by interlocking plates 6 or headers 7 to bottom wall 112 of container or tray 12, with concave side 202 of reflection/scattering element 2 and the cover element 4 facing towards the open side of container or tray 12.

The plan size of container or tray 12, i.e. the plan size of the surface to be illuminated, and the plan shape of container or tray 12 are exact multiples of the size of radiating element 1. The front side of the light panel is equipped with a plate 14 of transparent or translucent material, in direct contact with the front side, i.e. the covering elements of the array of radiating elements 1, or somewhat spaced therefrom by means of spacer elements. Plate 14 bears a communication message drawn directly thereon or on a support separate from plate 14. A cover 15 with a window 115 closes the front of the light panel to overlie a peripheral strip of plate 14 in a frame-like fashion, and may include side walls 215 overlying side walls 212 of container or tray 12.

Container or tray 12 has elements 16 at its back for coupling to a support, such as a wall, a post or other means. Furthermore, container or tray 12 has a tight opening for receiving power leads 17. These leads may be connected to any power source, power being transformed by a power supply unit 18, which may be located wholly or partly outside or inside the panel.

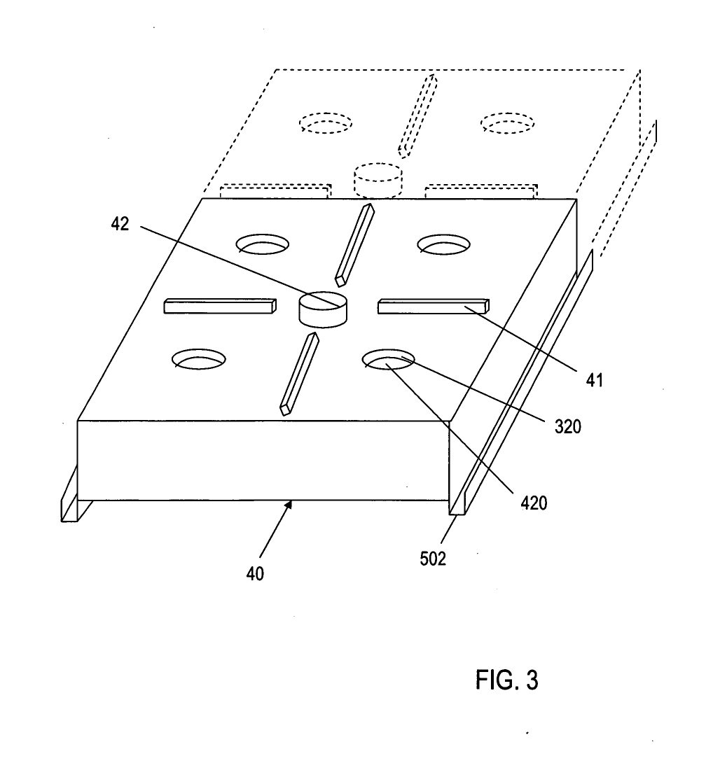

FIGS. 3 to 14 show a different embodiment of the light panel, providing integration of two or more single radiating elements, i.e. radiating elements having each at least one light source, in a multiple radiating element, for example, a double, triple, quadruple or sextuple element. An array of such multiple radiating elements may be provided to cover various areas, possibly having different plan shapes.

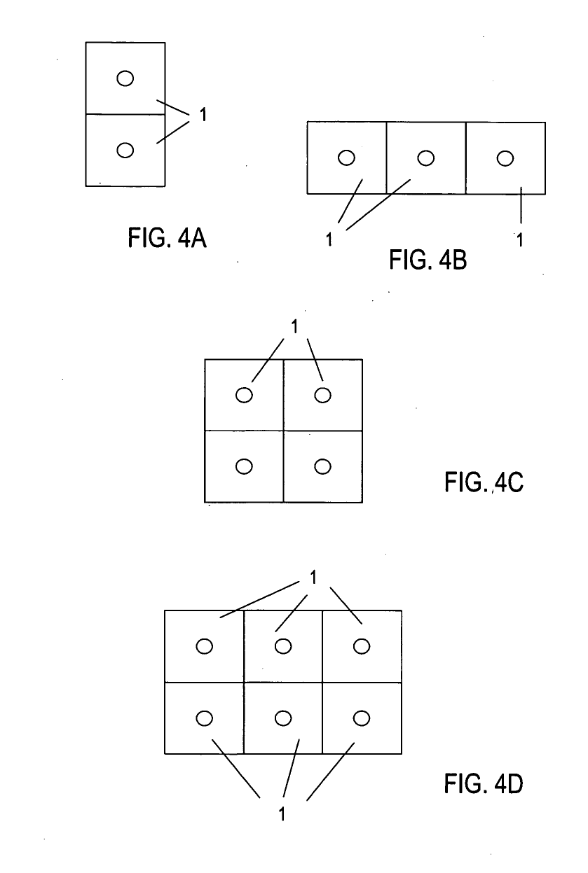

FIGS. 4A-4D show multiple panels composed of two, three, four, five and six single radiating elements 1 having a square plan shape.

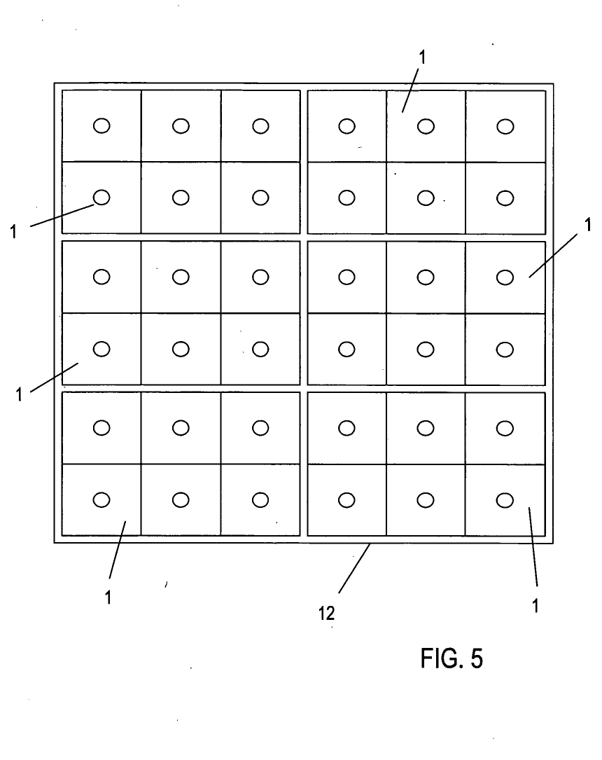

FIG. 5 shows a plan view of an exemplary light panel in which translucent plate 14 is illuminated by a plurality of multiple radiating elements, each composed of six single radiating elements 1. The figure shows container 12 or tray accommodating six multiple radiating elements 1.

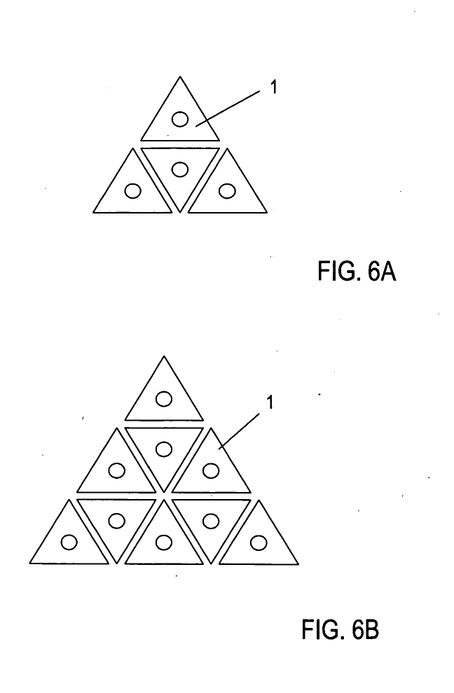

FIGS. 6A-6B show multiple radiating elements composed of a plurality of single triangular radiating elements 1, which are combined to form larger triangular emitting surfaces. The figures are intended to be schematic, and do not provide construction details.

Arrays may be further provided with single and multiple radiating elements having different plan shapes. For instance, arrays of single and multiple radiating elements may include single radiating elements of isosceles triangular and square plan shapes, each triangular radiating element being identical to the diagonal half of the square element, whereas the multiple radiating elements are composed of one or more square radiating elements and one or more single triangular radiating elements or combinations of one or more of said square and triangular radiating elements.

FIGS. 3 and 10 to 14 show in greater detail an embodiment of a reflection/scattering element for a multiple radiating element integrating six single radiating elements.

The reflection/scattering assembly designated by numeral 20 includes a half-shell which is shaped to include six depressions in side-by-side relationship, disposed in one or both directions of extension of such half-shell, each of the six depressions providing the convex side 202 of one reflection/scattering element 2 for a single radiating element. Such radiation/scattering assembly defines a multiple reflection/scattering element that may be coupled to a multiple light radiation emitting element (such as a transparent or translucent plate that carries a message to be displayed) to form a multiple radiating element. Advantageously, reflection/scattering assembly 20 is also formed as a relatively thin plate made of plastic or other material as described above with regard to single radiating element 1 of FIG. 1. Concave side 202 also has all the above described features as for single radiating element 1 and, because single radiating element 1 is embodied a square radiating element, it is joined to neighboring single radiating elements along common edges.

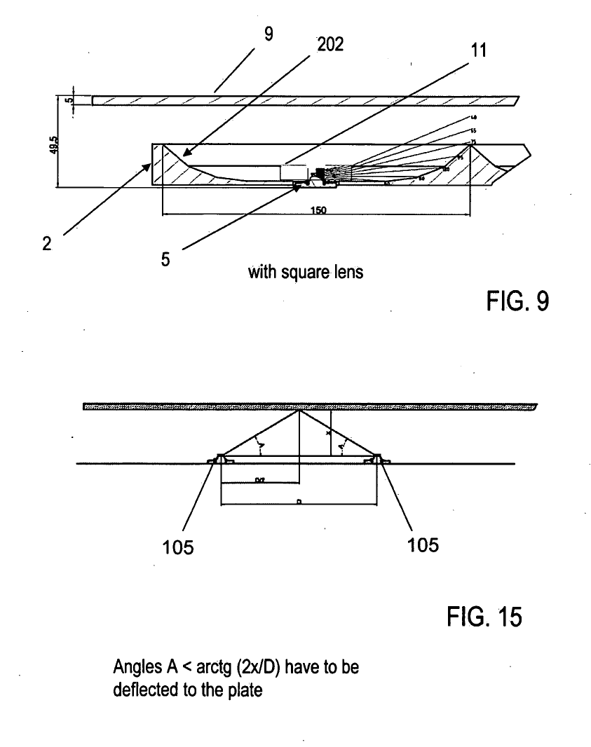

Accordingly, plate 14 has a single-piece construction, whereas the central portion, coaxial with the central axis of the plan shape (still as described above for single radiating element 1), includes the receptacle of light source 5, which is also of the radial or edge-emitting type relative to the central axis of symmetry. In the variant of FIGS. 10 to 14, an annular lens 11 of frustoconical section, as described with reference to FIG. 8, is provided around emitting head 105 of each of light sources 5. Nonetheless, such lens 11 can also be omitted, as mentioned above with reference to the single radiating element.

Still with reference to FIGS. 10 to 14, and more particularly to FIG. 13B, the construction of radiation/scattering assembly 20, which integrates in this case six single radiating elements, may be provided in other patterns with more or less than six elements and enables a one-piece construction of the metal heat dissipation plate designated by numeral 6, providing for improved efficiency. A single header 7 includes the power supply circuits or parts thereof for two or more LEDs or all the LEDs of the radiation/scattering assembly 20.

In the present embodiment, header 7 is formed as an elongate element having an extension that overlie three receptacles 102 of the three light sources 5 of three adjacent single radiating elements aligned along a longitudinal direction of radiation/scattering assembly 20. Particularly, as shown in FIG. 14, each LED adheres to heat dissipation plate 6 by its socket or base 205, whereas header 7 has a through opening coincident with emitting head 105 of the LED. Receptacle 102 is provided in the corresponding reflection/scattering element and emitting head 105 projects through such opening from the side of header 7 opposite the one facing towards heat dissipating plate 6. Thus, base 205 of LED 5 is interposed between header 7 and plate 6.

During assembly, light sources 5 (here embodied as LEDs) are mounted onto header 7 by connecting the LED contacts to the corresponding tracks and, in the position illustrated in FIG. 14, socket 205 adheres to the rear side of header 7 (considering the direction of illumination of the radiating element) and the emitting head 105 projects out of the front side of the header 7. The assembly of header 7 and of the three LEDs 5 is performed separately by providing a construction unit to be later mounted onto heat dissipation plate 6, and by having reflection/scattering assembly 20 associated therewith by fitting the heads of LEDs 5 in apertures or receptacles 102 of the concave surfaces 202.

According to yet another feature of the present invention, header 7 may be selected to obtain 2 and 1 LED elements.

Frustoconical annular lenses 11, with head 105 of light source 5 held therein, are associated with receptacles 102.

The embodiment of FIGS. 11 to 14 is a construction variant of the embodiment of the previous figures and of the single radiating element, because it does not have a covering or closing element like closing or covering element 4 of the single radiating element.

In this variant the radiation emitted by the LED in the direction of the central axis of symmetry is attenuated by an attenuation element with a predetermined transmission coefficient, which is integrated, or is or can be coupled, possibly in a detachable manner, to annular lens 11. Particularly, in the embodiment of FIGS. 11 to 14, attenuating element 21 is a disk of transparent or translucent material engaging in the central opening of annular lens 11. This disk lies over emitting head 105 on the front side of the radiating element. Otherwise, the disk may have a larger diameter and overlie the front end side of lens 11 and have a thicker portion in the central portion, to be adapted for interlocking engagement in the central opening of annular lens 11.

Nevertheless, the radiation/scattering assembly may be similar to the single radiating element of FIG. 1, in that it includes a covering or closing element 40, which is a multiple element integrating two or more single closing or covering elements in one part.

Such multiple closing or covering element 40 preferably has a plan shape corresponding to the plan shape of reflection/scattering assembly 20 and is formed of single covering or closing elements having a shape and size that corresponds to those of single reflection/scattering element 2 integrated in reflection/scattering assembly 20 and located in a position coincident, centered and coaxial therewith.

Multiple covering or closing element 40 has a portion 420 coincident with each of the light sources, with a predetermined transmission coefficient for attenuating the emission of said sources in the direction of the central axis of symmetry of each concave reflection/scattering surface of the single reflection/scattering elements that form the multiple radiating element.

Portion 420 may include a depression 320 as described for the single radiating element embodiment.

Concerning closing and covering element 40 of the reflection/scattering assembly, means may be provided coupling the reflection/scattering assembly 20 therewith that are formed in the same manner as those of the single radiating element, reference being made here to the description thereof.

Closing and covering element 40 may be also constructed like covering element 4 for a single radiating element, i.e. may be produced from a thin plate or sheet of transparent or translucent plastic material, which is shaped by a molding process. Once again, the sheet or plate has such thicknesses and is made of such materials as to preferably enable vacuum and hot forming.

In FIG. 3, the covering or closing element 40 integrates four single covering elements, whereas a closing or covering element suited for six single covering elements is indicated by dashed lines.

Still in FIG. 3, closing or covering element 40 may include stiffening ribs, designated by numeral 41, which are substantially coincident with the peripheral areas of concave sides 202 of reflection/scattering assembly 20.

In addition to or instead of stiffening ribs 41, the closing or covering element 40 may have projecting spacers 42 for spacing a translucent or transparent plate of a light panel like the one designated by numeral 14 in FIG. 2.

In the example of FIG. 3, closing or covering element 40 include a concavo/convex shape or shapes, for example, a substantially non-planar half-shell as described with reference to FIG. 1. This variant is applicable to the single covering element 4 of FIG. 1 and vice versa.

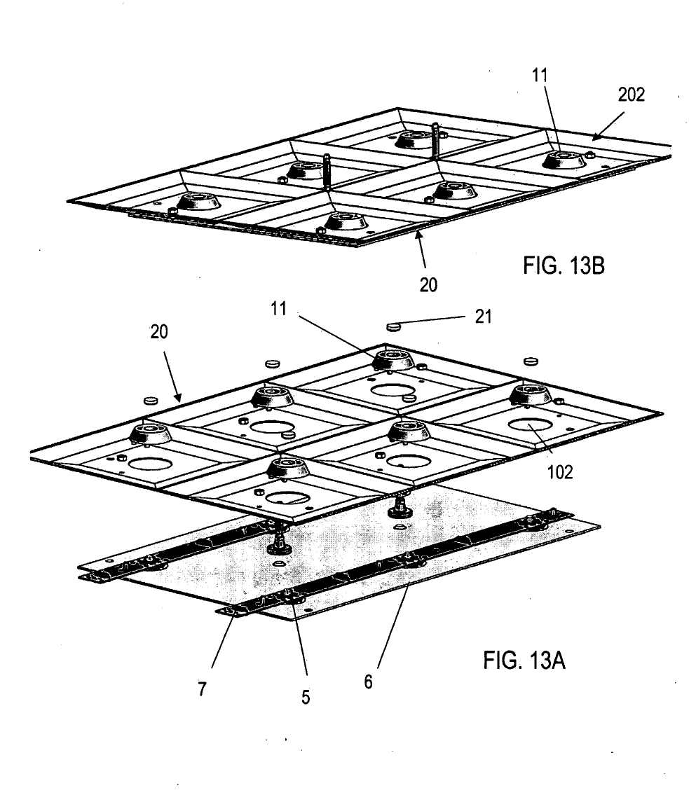

Referring now to the example of FIG. 15, in a basic embodiment of the present invention a single or multiple radiating element is provided, which has one radial or edge-wise light emitting source as defined in the present description. In this configuration, in order to ensure uniform intensity of the light emitted through emitting surface 9 or through the surface of a plate like the one designated by numeral 14 in FIG. 2, a predetermined position has to be set between the distance of emitting head 105 from the emitting surface 9 and the lateral distance of individual heads 105 of two or more LEDs or light sources from each other.

A solution was found to be provided by a relative arrangement of the LEDs or light sources 5, particularly heads 105 thereof (considered here as point light sources) and by a distance of heads 105 from the emitting surface that fulfill the following condition:

angle A<arctg (2x/D)

wherein:
D is the distance between the points that define the position of the emitting heads 105 of two adjacent light sources 5; and
x is the distance of the plane containing said points from the emitting surface, and more particularly from the facing side of a plate that acts as an emitting surface.

Therefore, in accordance with the above description, a construction may be provided for single or multiple radiating elements, with a light source supporting plate that has a radial or edge-wise light emitting source at its center (as defined herein). The plate has a size such that the radius of said plate or of a circle inscribed in the plan shape of said plate or inscribing the plan shape of said plate is equal to D/2, whereas a covering surface is associated with the plate at such a distance therefrom as to fulfill the above condition.

In one embodiment, the LED supporting plate may be heat dissipating plate 6 and/or header 7 according to one or more of the variants described for one or more of the above embodiments, whereas the emitting surface may be formed as a concavo-convex dome, in which the concave side faces towards supporting plate 6, thereby forming a closed compartment. This configuration also provides for a box-like radiating element. Once again, the dome-shaped element may be detachably or permanently coupled to the supporting plate, which may be configured as described above for one or more of the previous embodiments.

It will be appreciated that multiple radiant elements may be also provided that integrate two or more single radiating elements having constructive features of one or more of the previous embodiments of multiple radiating elements.

More particularly, a multiple radiating element may include at least two light sources mounted onto a supporting plate in a central position relative to two adjacent areas of said plate, each of which areas having such a size that the radius of said area, i.e. of a circle inscribed in the plan shape of said area or inscribing the plan shape of said area, is equal to D/2.

The emitting surface may be associated to the plate, or the plate may be equipped with spacer elements for spacing an emitting surface or be provided in combination with a structure having such spacer elements, with the distance of the emitting surface being equal to a distance x that fulfills the above condition.

Finally, the embodiment of FIG. 15 provides for a very simple construction of the light panels with a minimized number of parts. Particularly, in a panel as shown in FIGS. 2 and/or 5, heat dissipation plate 6 may be omitted and LEDs 5 may be mounted onto headers 7 similar to those of the example of FIG. 13B. Further, headers 7 may be directly coupled to the bottom of tray 12, whereas tray 12 is equipped with spacer elements, on which transparent or translucent plate 14 is designed to rest, and which are disposed to provide a distance x from the plane containing the points that define the light radiation source positions of the light sources.

Still further, a number of variant embodiments may be provide with regard to the construction of the headers and/or the LED supporting plate.

Therefore, a panel as disclosed above has a support element for one or more plates, each carrying one or more LEDs in mutually offset positions, with the emitting heads contained in a common plane and with a transparent or translucent plate, provided at a predetermined distance from said emitting head containing plane. In this panel, the distance D between the emitting heads and the distance x of the emitting heads from the transparent or translucent plate is determined by the following condition:

angle A<arctg (2x/D).

Finally, concerning the radiating element of FIG. 15, lenses such as those of FIGS. 9 or 10 and/or attenuation elements such as those 21 of FIGS. 11 and 14, and/or such as those designated by numerals 402, 302 in FIG. 1 may be also associated with the heads of light sources 5.

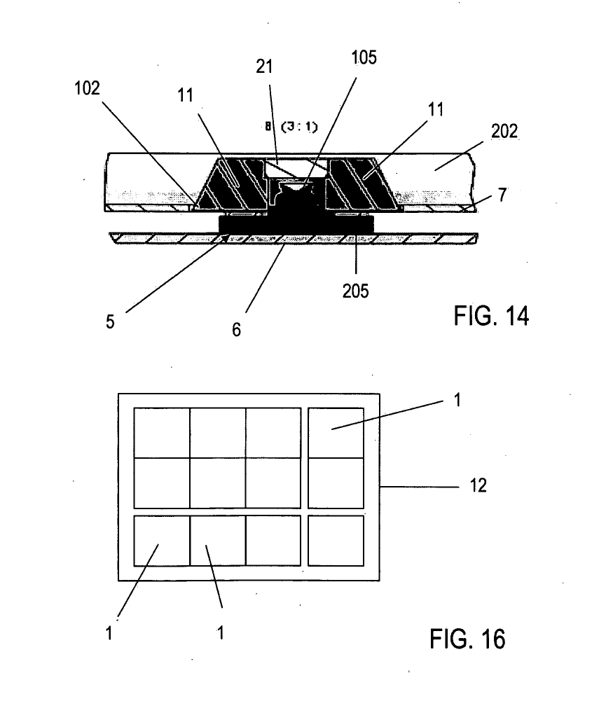

FIG. 16 illustrates an exemplary light panel, in which the radiating element is composed of a plurality of elements, each having a different number of square base radiating elements. FIG. 16 shows one of the many possible examples and is only intended for illustration purposes. The example of FIG. 16 provides a combination of radiating elements integrating six, three, two and one base radiating elements respectively. The separation of the various multiple radiating elements is graphically indicated by a spacing, whereas each multiple radiating element is shown as including the corresponding amount of base radiating elements in direct contact with each other. FIG. 16 also shows the peripheral edge of the base casing, which is part of the panel frame and receives the above mentioned radiating elements.

While the invention has been described in connection with a number of embodiments, it is not intended to limit the scope of the invention to the particular forms set forth, but on the contrary, it is intended to cover such alternatives, modifications, and equivalents as may be included within the scope of the invention.

What is claimed is:

1. A radiating element for light panels, the radiating element being in tessera or tile form, the radiating element comprising:
a light source emitting sideward light, the sideward light being emitted with a predetermined emission angle in relation to a longitudinal axis of the light source;
a reflection/scattering element housing the light source and reflecting and scattering the sideward light incident upon the reflection/scattering element; and
a light emitting element receiving the light reflected and scattered from the reflection/scattering element,
wherein the reflection/scattering element comprises a half-shell shaped plate having a polygonal or round plan shape and a concave reflection/scattering side facing towards the light source,
wherein the half-shell shaped plate has a central opening for receiving the light source,
wherein the light source has a radiating head at a focal point of the concave reflection/scattering side, and
wherein the sideward light is reflected and scattered in a predetermined percentage and in a direction incident upon the light emitting element, and
wherein the light emitting element is disposed transversally to a central axis of symmetry of the reflection/scattering element.

2. The radiating element as claimed in claim 1, wherein the concave reflection/scattering side has a reflective, mirror-like finish.

3. The radiating element as claimed in claim 1, wherein the light emitting element is disposed perpendicularly to the central axis of symmetry.

4. The radiating element as claimed in claim 1, wherein the concave reflection/scattering element has a paraboloidal curvature.

5. The radiating element as claimed in claim 1, wherein the light source is a radial or edge-wise light emitting light emitting diode (LED) with a 360 degree light pattern.

6. The radiating element as claimed in claim 1, wherein the concave reflection/scattering element is closed by the light emitting element with coupling means for connecting a peripheral edge of the light emitting element to a peripheral edge of the reflection/scattering element, and wherein the light emitting element is transparent or translucent.

7. The radiating element as claimed in claim 6, wherein the light emitting element has the same plan shape as the reflection/scattering element and is substantially congruent with the plan shape of the reflection/scattering element.

8. The radiating element as claimed in claim 6, wherein the coupling means engage with complementarily shaped end portions the peripheral edges of the reflection/scattering element and of the light emitting element, and wherein the coupling means extend continuously or discontinuously along the peripheral edges.

9. The radiating element as claimed in claim 8, wherein the coupling means comprise one or more clips having folded peripheral edges or peripheral edge segments that engage opposite peripheral coupling grooves along the peripheral edges of the reflection/scattering element and of the light emitting element.

10. The radiating element as claimed in claim 1, wherein the light emitting element comprises a central portion that is substantially opposite to the light source and that has a lower light transmission coefficient than a surrounding portion of the light emitting element, and wherein the central portion attenuates an intensity of the received sideward light to at least substantially the same level as an intensity of the sideward light received in the surrounding portion.

11. The radiating element as claimed in claim 10, wherein the central portion is depressed in relation to the surrounding portion, and wherein a bottom of the central portion is treated for reducing the light transmission coefficient.

12. The radiating element as claimed in claim 1, wherein the reflection/scattering element and/or the light emitting element are made of a plastic material.

13. The radiating element as claimed in claim 1,
wherein the light source is mounted onto a header of a printed circuit board, the header bearing tracks of the printed circuit board that form a power supply circuit or power regulating circuit for the light source, and
wherein the header is coupled to a convex side of the reflection/scattering element in an area where the light source is housed, the light source projecting cantilever-wise out of the concave reflection/scattering side.

14. The radiating element as claimed claim 1,
wherein the light source is mounted onto a metal plate, the metal plate allowing heat dissipation and a coupling of the radiating element to a load bearing structure,
wherein the metal plate is disposed tangent, or parallel to a tangent, of a convex side of the reflection/scattering element in an area where the light source is housed, the light source projecting cantilever-wise out of the concave reflection/scattering side of the reflection/scattering element, and
wherein the reflection/scattering element is configured to be coupled to the metal plate.

15. The radiating element as claimed in claim 14, wherein a header of a printed circuit board of a power supply circuit or power regulating circuit for the light source are also mounted onto the metal plate in an area peripherally surrounding the light source, thereby causing the convex side of the reflection/scattering element to be spaced from the metal plate.

16. The radiating element as claimed in claim 14, further comprising a connection socket interposed between the metal plate and a header for a power supply or power regulation circuit for the light source, the header being adjacent to the reflection/scattering element and having an opening for projecting at least a portion of the light source towards the concave reflection/scattering side.

17. The radiating element as claimed in claim 15, wherein the metal plate is dimensioned not to project beyond peripheral edges of the reflection/scattering element.

18. The radiating element as claimed in claim 1, wherein the radiating element has a diameter between about 5 cm and 30 cm.

19. The radiating element as claimed in claim 1, wherein the reflection/scattering element is formed of a metal sheet having a side forming the concave radiation/scattering side that is treated to become reflective or coated with a material providing a scattering effect.

20. The radiating element as claimed in claim 1, wherein two or more radiating elements are integrated in a multiple radiating element having a multiple reflection/scattering element and a multiple light emitting element, and wherein the multiple radiating element is formed from a single sheet of material shaped to provide two or more concave reflection/scattering sides adjacent to one another.

21. The radiating element as claimed in claim 20, wherein the multiple light emitting element is composed of a plurality of adjacent light emitting elements that are integrally connected, wherein each of the adjacent light emitting elements comprises a central portion with a lower light transmission coefficient, and wherein each of the central portions is essentially coaxial with one light source.

22. The radiating element as claimed in claim 21, wherein the multiple light emitting element is coupled to the multiple reflection/scattering element with means for connecting peripheral edges substantially equal to means for connecting peripheral edges of a single radiating element.

23. The radiating element as claimed in claim 1, wherein two or more radiating elements form a multiple radiating element, wherein at least some of the two or more radiating elements are mounted onto a common metal support plate or to a common header for a power supply or power regulation circuit for the light source mounted to the common support plate, and wherein each of the two or more radiating elements are mounted in a position coincident with a receptacle of one light source.

24. The radiating element as claimed in claim 23, wherein the multiple light emitting element is composed of a plurality of adjacent light emitting elements that are integrally connected, wherein each of the adjacent light emitting elements comprises a central portion with a lower light transmission coefficient, wherein each of the central portions is essentially coaxial with one light source, and wherein the multiple light emitting element comprises one or more stiffening ribs arranged in a predetermined pattern over a surface of the multiple light emitting element.

25. The radiating element as claimed in claim 24, wherein the multiple light emitting element further comprises a plurality of projecting spacers to space a transparent or translucent plate interposed between the light sources and the multiple light emitting element, wherein the spacers are other than the one or more stiffening ribs or comprise at lest a portion of the one or more stiffening ribs.

26. The radiating element as claimed in claim 1, wherein a plurality of radiating elements are arranged in an array providing one of a plurality of shapes and sizes.

27. The radiating element as claimed in claim 26, wherein the plurality of radiating elements each have the same plan shape.

28. The radiating element as claimed in claim 26, wherein the array comprises radiating elements of a plurality of plan shapes arranged and sized to be combined together.

29. The radiating element as claimed in claim 1, wherein the light source is surrounded by an annular lens.

30. The radiating element as claimed in claim 29, wherein the annular lens has either a rectangular, square, or right trapezoidal cross section.

31. The radiating element as claimed in claim 29, further comprising an attenuating element coupled with the annular lens, the attenuating element attenuating light emitted from the light source along a longitudinal axis of the annular lens, the attenuating element having a predetermined transmission coefficient.

32. The radiating element as claimed in claim 31, wherein the attenuating element comprises a disk disposed in or over a central opening of the annular lens above the light source.

33. The radiating element as claimed in claim 29, wherein the annular lens is detachably coupled to the radiating head of the light source, and wherein a surface of the annular lens adjacent to the reflection/scattering element is reflective so to light incident upon the surface is reflected towards the light emitting element.

34. The radiating element as claimed in claim 33, wherein the surface of the annular lens adjacent to the reflection/scattering element is rendered reflective by a white layer.

35. A light panel comprising:
a light source emitting sideward light, the sideward light being emitted with a predetermined emission angle in relation to a longitudinal axis of the light source; and
a light emitting element receiving the light emitted from the light source,
wherein the light source is located at a center of a radiating element having a predetermined plan shape, and
wherein a radius of a circle inscribed in or inscribing the plan shape and the distance of the emitting surface from an emitting head of the light source fulfill the condition:
Angle A<arctg (2x/D)
wherein:
D is the diameter of the circle inscribed in or inscribing the plan shape; and
x is a distance of a plane containing a point defining a position of the light emitting element from the emitting head.

36. The light panel as claimed in claim 35, wherein the light panel comprises a plurality of light sources each mounted onto a common supporting plate in central positions within adjacent areas of the common supporting plate, and wherein D is equal to a distance between adjacent light sources.

37. The light panel as claimed in claim 35, wherein the light source is mounted onto a heat dissipating plate or a header of at least part of a power supply circuit or power regulating circuit, wherein the radiating element is a concavo-convex dome having a concave side that faces towards the supporting plate or the header and that is coupled to the light emitting element to form a closed compartment.

38. The light panel as claimed in claim 35, wherein the light emitting element is coupled to the radiating element or is spaced from the radiating element by one or more spacers so to form a box-shaped structure fulfilling the condition of claim 33.

39. The light panel as claimed in claim 35, wherein the light emitting element is transparent, translucent, or partially transparent and partially translucent.

40. A light panel comprising:
a bearing frame supporting a plurality of light sources; and
a plate bearing or supporting graphical information, the plate being formed by a combination of one or more of transparent or translucent surfaces having one or more of different colors or light transmission coefficients,
wherein the light panel includes one or more radiating elements each comprising,
a light source emitting sideward light, the sideward light being emitted with a predetermined emission angle in relation to a longitudinal axis of the light source, and
a reflection/scattering element housing the light source and reflecting and scattering light incident upon the reflection/scattering element;
wherein the reflection/scattering element comprises a half-shell shaped plate having a polygonal or round plan shape and a concave reflection/scattering side facing towards the light source,
wherein the half-shell shaped plate has a central opening for receiving the light source,
wherein the light source has a radiating head at a focal point of the concave reflection/scattering side, and
wherein the sideward light is reflected and scattered in a predetermined percentage in a direction incident upon the light emitting element, and
wherein the light emitting element is disposed transversally to a central axis of symmetry of the reflection/scattering element.
